(19) United States
(12) Patent Application Publication
(10) Pub. No.: US 2007/0246633 A1
(43) Pub. Date: Oct. 25, 2007

(54) Adjustable eccentric mounting apparatus

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 11/784,214

(22) Filed: Apr. 5, 2007

Related U.S. Application Data
(63) Continuation-in-part of application No. 11/118,734, filed on Apr. 29, 2005.
(63) Continuation-in-part of application No. 11/120,286, filed on May 2, 2005.
Application No. 11/120,286 is a continuation-in-part of application No. 11/118,734, filed on Apr. 29, 2005.
(63) Continuation-in-part of application No. 11/125,700, filed on May 10, 2005.
Application No. 11/125,700 is a division of application No. 11/118,734, filed on Apr. 29, 2005.

(51) Int. Cl. F16M 13/00

(52) U.S. Cl. 248/544

(57) ABSTRACT

A free standing pole mount having a novel adjustable eccentric mounting apparatus for adjusting positioning of the pole throughout an entire radial and volumetric range of the pole along a length of the pole. The eccentric mounting apparatus includes first and second substantially rigid frames each being fully rotatably coupled to opposite lobes of a dual lobe eccentric coupler such that the second frame is fully rotatable relative to the first frame. Accordingly, the second frame is easily movable without limitation throughout its entire radial range relative to the first frame.

The present application is a Continuation-in-part of co-pending U.S. patent application Ser. No. 11/118,734 filed in the name of the inventor of the present application on Apr. 29, 2005, which is incorporated herein by reference, and is a Continuation-in-part of co-pending U.S. patent application Ser. No. 11/120,286 filed in the name of the inventor of the present application on May 2, 2005, which is a Continuation-in-part of U.S. patent application Ser. No. 11/118,734 and is incorporated herein by reference, and is a Continuation-in-part of co-pending U.S. patent application Ser. No. 11/125,700 filed in the name of the inventor of the present application on May 10, 2005, which is a Divisional of U.S. patent application Ser. No. 11/118,734 and is incorporated herein by reference.

### FIELD OF THE INVENTION

The present invention relates to a free standing pole mount for mounting an external device at a selected relationship to a fixed base, and in particular to a pole mount having an internal locking mechanism for securing the pole at a selected radial and rotational position relative to the fixed base.

### BACKGROUND OF THE INVENTION

Pole mounts are generally well known. However, adjustment of such known telescoping pole mounts is restricted in general tend to lengthwise along the pole. Pole mounts that also provide rotational or radial adjustment generally fail to provide positioning within the volume actually occupied by the pole. Accordingly, the known pole mounts are unable to provide positioning throughout the entire radial area within range of the pole. Consequently, such known pole mounts are unable to provide positioning throughout the entire radial volume within range of the pole along the length of the pole.

Consequently, it is desirable to have improvements in the radial and volumetric positioning of pole mounts.

### SUMMARY OF THE INVENTION

The present invention is a novel free standing pole mount for mounting an external device at a selected relationship to a fixed base, the pole mount having an internal locking mechanism for securing the pole at a selected radial and rotational position relative to the fixed base.

According to one aspect of the invention the novel free standing pole mount includes a novel adjustable eccentric mounting apparatus for adjusting positioning of the pole throughout an entire radial and volumetric range of the pole along the length of the pole. Accordingly, according to one aspect of the novel adjustable eccentric mounting apparatus the novel adjustable eccentric mounting apparatus includes a pair of first and second substantially rigid frames each having a first mounting face formed at a base portion thereof that is structured for being fixedly attached to a mounting surface and a second mounting face formed on the base portion opposite from the first face. A dual lobe eccentric coupler is rotatably coupled between the second mounting faces of the first and second frames with a first lobe portion of the coupler being fully rotatably coupled to the second face of the first frame, and a second lobe portion of the coupler being laterally offset from the first lobe portion and being fully rotatably coupled to the second face of the second frame. An internal locking mechanism is provided between the coupler and each of the first and second frames for securing the first mounting face of the second frame at a selected radial and rotational lateral position relative to the first mounting face of the first frame. Accordingly, the first mounting face of the second frame is easily movable without limitation throughout its entire radial range relative to the first mounting face of the first frame.

According to another aspect of the novel free standing pole mount, the novel adjustable eccentric mounting apparatus further includes a first fully rotatable coupling that is rotatably coupled between the first lobe portion of the coupler and the second mounting face of the first frame, and a second fully rotatable coupling that is rotatably coupled between the second lobe portion of the coupler and the second face of the second frame.

According to another aspect of the novel free standing pole mount, each of the first and second fully rotatable couplings of the novel adjustable eccentric mounting apparatus further includes an externally tapered male axel portion and a mating internally tapered female socket portion.

According to another aspect of the novel free standing pole mount, the second face of each of the first and second frames of the novel adjustable eccentric mounting apparatus further includes the male axel portion of one of the fully rotatable couplings, and the eccentric coupler further includes a pair of the mating female socket portions with a first one of the mating female socket portions being recessed in the first lobe portion of the coupler, and a second one of the mating female socket portions being recessed in the second lobe portion of the coupler, wherein the second one of the mating female socket portions is oriented facing in a substantially opposite direction from the first one of the mating socket portions.

According to another aspect of the novel free standing pole mount, the first mounting face of each of the first and second frames of the novel adjustable eccentric mounting apparatus further includes a pattern of a plurality of mounting holes formed therein and being positioned eccentric of the male axel portion of the fully rotatable coupling.

According to another aspect of the novel free standing pole mount, the first and second frames of the novel adjustable eccentric mounting apparatus are further formed as substantially identical frames.

According to another aspect of the novel free standing pole mount, the eccentric coupler of the novel adjustable eccentric mounting apparatus is further formed as being substantially inversely symmetric about a center line plane bisecting the coupler.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of the novel pole mount and the novel adjustable eccentric mounting apparatus for mounting the pole;

FIG. 2 illustrates the novel adjustable eccentric mounting apparatus with the post or pole mount removed for clarity;

FIG. 3 is a side view of the novel adjustable eccentric mounting apparatus with the post or pole mount removed for clarity and a second portion of the novel adjustable eccentric mounting apparatus being substantially fully extended on an eccentric coupler a maximum distance from a first portion of the novel adjustable eccentric mounting apparatus;

FIGS. 4, 5, 6 and 7 are top views of the novel adjustable eccentric mounting apparatus with the post or pole mount removed for clarity, wherein FIG. 4 illustrates the novel adjustable eccentric mounting apparatus with the second portion being extended on the eccentric coupler a maximum distance from the first portion, FIG. 5 illustrates the novel adjustable eccentric mounting apparatus having the second portion being rotated from the substantially fully extended position (illustrated in phantom lines) on the eccentric coupler to a generally median distance from the first portion with both the first and second portions being partially rotated in opposite directions on the rotatable couplings eccentric coupler while patterns of mounting or bolt clearance holes remain substantially parallel, FIG. 6 illustrates the novel adjustable eccentric mounting apparatus having the second portion being rotated from the substantially fully extended position (illustrated in phantom lines) on the eccentric coupler to a minimum distance from the first portion while patterns of mounting or bolt clearance holes remain substantially parallel; FIG. 7 illustrates the novel adjustable eccentric mounting apparatus with the second portion being rotated from the substantially fully extended position (illustrated in phantom lines) on the eccentric coupler to a generally median distance from the first portion with both the first and second portions being partially rotated in same directions on the eccentric coupler such that the second portion is moved to a position closer to the first portion and lateral thereof vis-à-vis the substantially fully extended position and the pattern of mounting or bolt clearance holes on the second portion is rotated relative to the pattern of mounting or bolt clearance holes on the first portion, and FIG. 8 illustrates the novel adjustable eccentric mounting apparatus having the second portion being rotated from the substantially fully extended position (illustrated in phantom lines) on the eccentric coupler to a position substantially directly over the first portion with both the portions being partially rotated in same directions on the eccentric coupler such that the pattern of mounting or bolt clearance holes on the second portion is rotated into substantially alignment with the pattern of mounting or bolt clearance holes on the first portion; and

FIG. 9 is a cross-section view of the novel adjustable eccentric mounting apparatus having the second portion being extended on the eccentric coupler a maximum distance from the first portion with a rotatable couplings formed between each of the first and second portions and the eccentric coupler being illustrated by example and without limitation as a projected male axel portion sized to fit into a mating recessed female socket portion.

### DETAILED DESCRIPTION OF PREFERRED EMBODIMENT

In the Figures, like numerals indicate like elements.

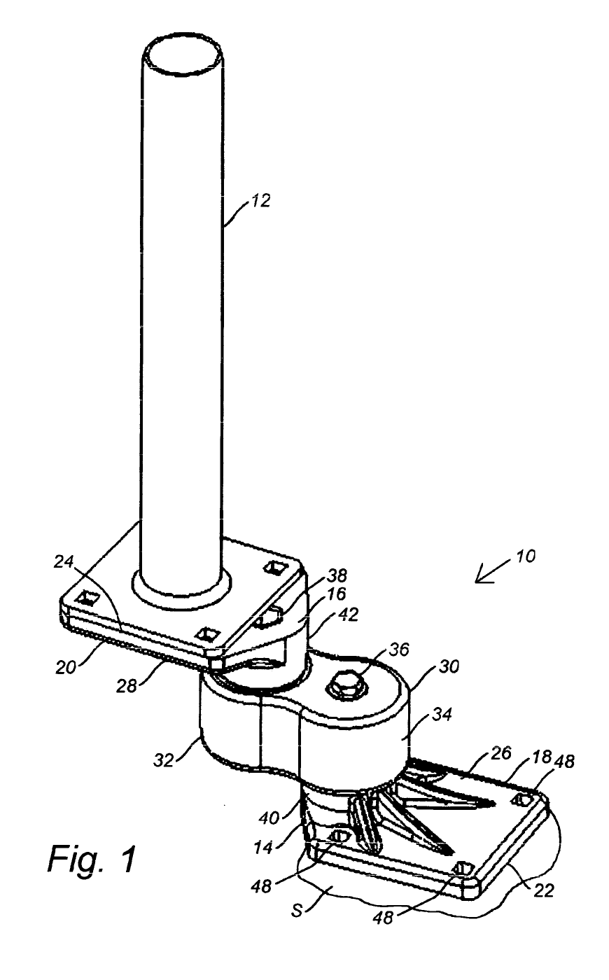

FIG. 1 is a perspective view that illustrates the invention as an adjustable eccentric mounting apparatus 10 for a mounting post or pole 12. By example and without limitation, the mounting post or pole 12 is optionally provided as a telescoping pole mount generally of the type disclosed in any of co-pending U.S. patent application Ser. No. 11/118,734 filed in the name of the inventor of the present application on Apr. 29, 2005, and co-pending U.S. patent application Ser. No. 11/120,286 filed in the name of the inventor of the present application on May 2, 2005, which is incorporated herein by reference, and co-pending U.S. patent application Ser. No. 11/125,700 filed in the name of the inventor of the present application on May 10, 2005, which is incorporated herein by reference, the mounting post or pole 12 having an internal locking mechanism for securing the telescoping pole at a selected elevation, and a disengaging mechanism for disengaging the internal locking mechanism. The adjustable eccentric mounting apparatus 10 includes first and second substantially rigid frames 14 and 16. Each of the frames 14, 16 are formed at a respective base portion 18 and 20 thereof with a respective first mounting face 22 and 24. For example, first mounting face 22 of the first frame 14 is mounted to a vehicle floor or other mounting surface S, and the mounting post or pole 12 is mounted to the first mounting face 24 of the second frame 16. The respective first mounting faces 22 and 24 are structured for being fixedly attached to a mounting surface. Each of the frames 14, 16 are also formed with respective second mounting faces 26 and 28 opposite from the respective first mounting faces 22 and 24.

Optionally, the first and second frames 14, 16 are formed as being substantially identical frames.

A dual lobe eccentric coupler 30 is rotatably coupled between the second mounting faces 26, 28 of the first and second frames 14, 16. A first eccentric lobe portion 32 of the coupler 30 is fully rotatably coupled to the second face 26 of the first frame 14. A second eccentric lobe portion 34 is laterally offset from the first lobe portion 32 and is fully rotatably coupled to the second face 28 of the second frame 16. Respective internal locking mechanisms 36 and 38 are provided between the coupler 30 and each of the respective first and second frames 14, 16 for securing the first mounting face 22 of the second frame 16 at a selected radial and rotational position relative to the first mounting face 24 of the first frame 14.

Optionally, the two eccentric lobe portions 32 and 34 of the coupler 30 are formed as being substantially identical lobes with the second lobe portion 34 by inverted relative to the first lobe portion 32. Accordingly, the coupler 30 is optionally inversely symmetric about a center line plane bisecting the coupler 30.

Fully rotatable couplings 40 and 42 are formed between the first and second eccentric lobe portions 32 and 34 of the dual lobe eccentric coupler 30 and the respective second mounting faces 26 and 28 of the respective frames 14 and 16. The couplings 40 and 42 are fully rotatable for selectively rotating each of the respective second mounting faces 26 and 28 of the respective frames 14 and 16 a full and uninterrupted 360 degrees relative to the respective first and second eccentric lobe portions 32 and 34 of the dual lobe eccentric coupler 30.

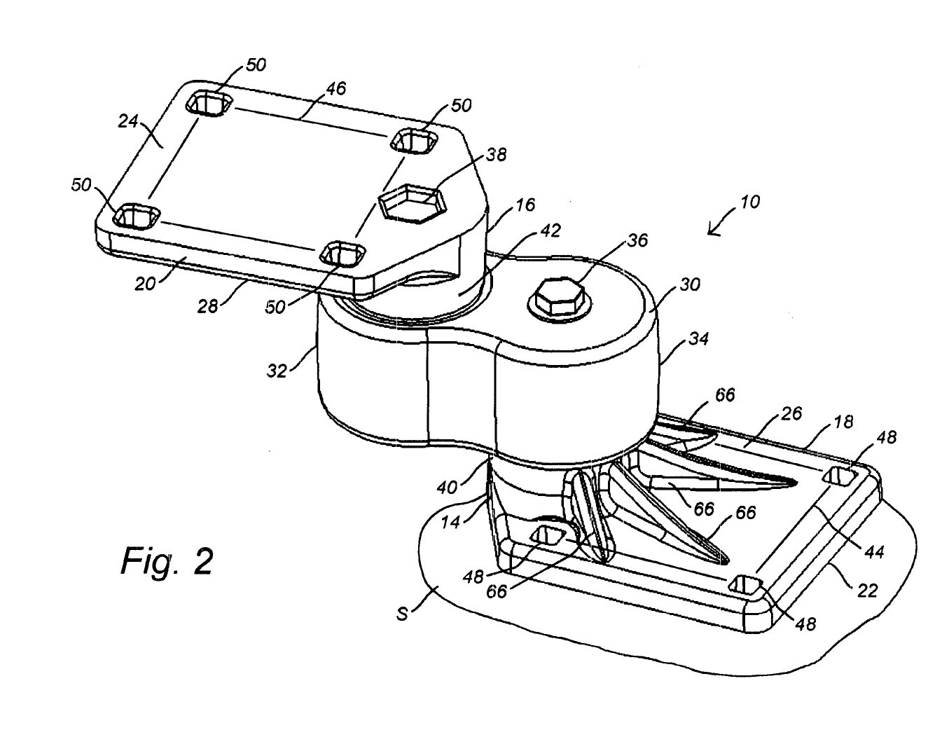

FIG. 2 illustrates the adjustable eccentric mounting apparatus 10 with the mounting post or pole 12 removed for clarity. Here, fully rotatably couplings 40 and 42 between the respective first mounting faces 22 and 24 are illustrated by example and without limitation as being eccentric of respective first and second patterns 44 and 46 of first and second mounting or bolt clearance holes 48 and 50 formed through the base portion 18 and 20 of respective frames 14 and 16. Accordingly, when the patterns 44 and 46 of mounting or bolt clearance holes 48 and 50 are formed eccentric of respective rotatable couplings 40 and 42, as illustrated here by example and without limitation, travel of the second pattern 46 of holes 50 in the second frame 16 is maximized relative to the first pattern 44 of holes 48 in the first frame 14. Thus, travel of the mounting post or pole 12, when present, is similarly maximized relative to the mounting position of the first frame 14 on the vehicle floor or other mounting surface S.

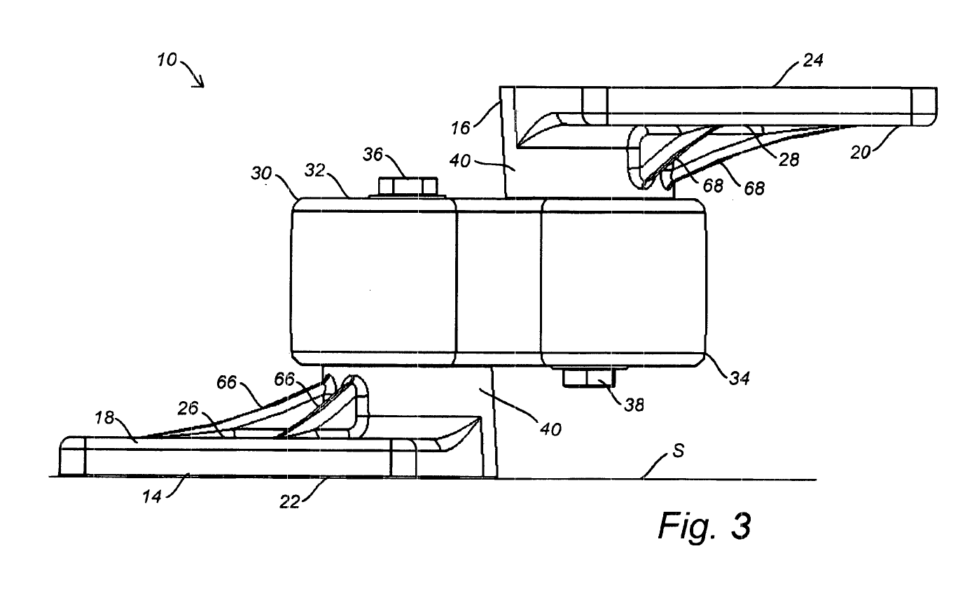

FIG. 3 is a side view of the adjustable eccentric mounting apparatus 10 with the second frame 16 being substantially fully extended on the eccentric coupler 30 a maximum distance from the first frame 14. Accordingly, when the patterns 44 and 46 of mounting or bolt clearance holes 48 and 50 are formed eccentric of respective rotatable couplings 40 and 42, as illustrated here by example and without limitation, the second pattern 46 of holes 50 in the base portion 20 of the second frame 16 is maximized relative to the first pattern 44 of holes 48 in the base portion 18 of the first frame 14. Thus, separation of the mounting post or pole 12, when present, is similarly maximized relative to the base portion 18 of the first frame 14 and its mounting position on the vehicle floor or other mounting surface S.

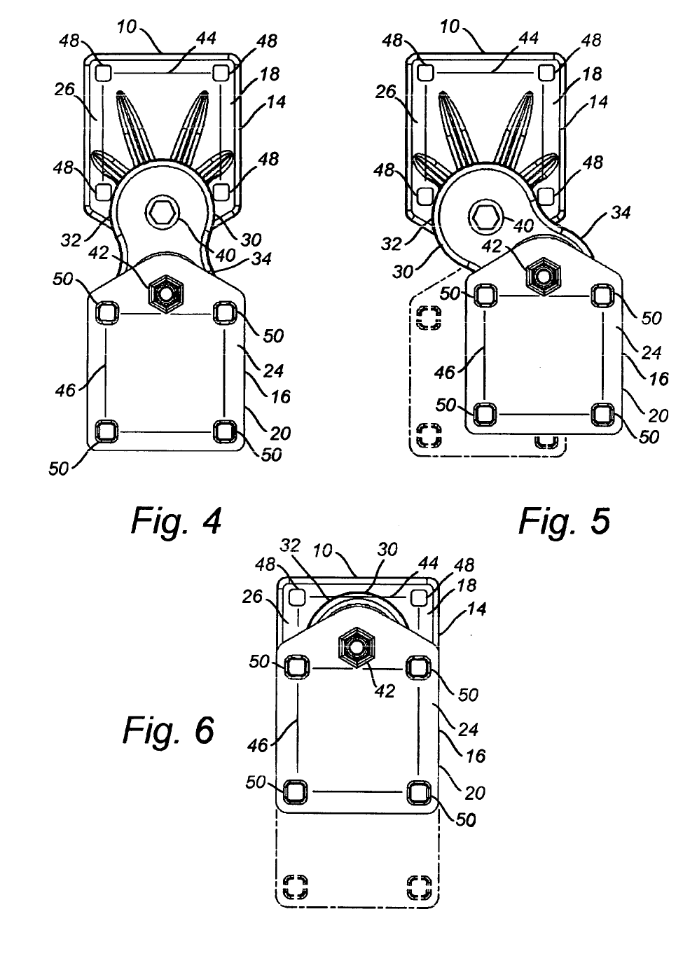

FIGS. 4, 5, 6 and 7 are top views of the adjustable eccentric mounting apparatus 10 with the mounting post or pole 12 removed for clarity. FIG. 4 illustrates the adjustable eccentric mounting apparatus 10 with the second frame 16 being extended on the eccentric coupler 30 a maximum distance from the first frame 14.

FIG. 5 illustrates the adjustable eccentric mounting apparatus 10 with the second frame 16 being rotated from the substantially fully extended position (illustrated in phantom lines) on the eccentric coupler 30 to a generally median distance from the first frame 14. Here, both the first and second frames 14 and 16 are partially rotated on the rotatable couplings 40 and 42 of the dual lobe eccentric coupler 30, but in opposite clockwise and counter-clockwise directions. Accordingly, the second frame 16 is moved from the substantially fully extended position to a new median position closer to the first frame 14 and lateral thereof, while the patterns 44 and 46 of mounting or bolt clearance holes 48 and 50 remain substantially parallel. Thus, when present the mounting post or pole 12 coupled to the base portion 20 of the second frame 16 is retained in a substantially identical rotational orientation relative to the base portion 18 of the first frame 14 and its mounting orientation relative to the vehicle floor or other mounting surface S, while being repositioned closer to the mount position of the base portion 18 of the first frame 14.

FIG. 6 illustrates the adjustable eccentric mounting apparatus 10 with the second frame 16 being rotated from the substantially fully extended position (illustrated in phantom lines) on the eccentric coupler 30 to a minimum distance from the first frame 14, while the base portion 20 of the second frame 16 is retained in a substantially identical orientation relative to the base portion 18 of the first frame 14 and its mounting orientation relative to the vehicle floor or other mounting surface S. Here, both the first and second frames 14 and 16 are rotated about one half or substantially 180 degrees on the rotatable couplings 40 and 42 of the dual lobe eccentric coupler 30, but in opposite clockwise and counter-clockwise directions. Accordingly, the second frame 16 is moved closer to the first frame 14 and is substantially aligned therewith, while the patterns 44 and 46 of mounting or bolt clearance holes 48 and 50 remain substantially parallel. Thus, when present the mounting post or pole 12 coupled to the base portion 20 of the second frame 16 is retained in a substantially identical orientation relative to the base portion 18 of the first frame 14 and its mounting orientation relative to the vehicle floor or other mounting surface S, while being repositioned even more closely to the mount position of the base portion 18 of the first frame 14. Optionally, from this position both the first and second frames 14 and 16 are rotated fully or substantially 360 degrees on the rotatable couplings 40 and 42 of the dual lobe eccentric coupler 30, whereby the second frame 16 is rotated back to the substantially fully extended position (illustrated in phantom lines) on the eccentric coupler 30 to substantially fully extended position, as illustrated in FIG. 4.

FIG. 7 illustrates the adjustable eccentric mounting apparatus 10 with the second frame 16 being rotated from the substantially fully extended position (illustrated in phantom lines) on the eccentric coupler 30 to a generally median distance from the first frame 14. Here, both the frames 14 and 16 are partially rotated on the rotatable couplings 40 and 42 of the dual lobe eccentric coupler 30, but in same clockwise or counter-clockwise directions. Accordingly, the second frame 16 is moved to a position closer to the first frame 14 and lateral thereof vis-a-vis the substantially fully extended position. Additionally, the pattern 46 of mounting or bolt clearance holes 50 on the base portion 20 of the second frame 16 is rotated relative to the pattern 44 of mounting or bolt clearance holes 48 on the base portion 18 of the first frame 14. Thus, when present the mounting post or pole 12 on the base portion 20 of the second frame 16 is rotationally re-orientated relative to the base portion 18 of the first frame 14 and its mounting orientation relative to the vehicle floor or other mounting surface S, while also being repositioned closer to and lateral of the mount position of the base portion 18 of the first frame 14.

FIG. 8 illustrates the adjustable eccentric mounting apparatus 10 with the second frame 16 being rotated from the substantially fully extended position (illustrated in phantom lines) on the eccentric coupler 30 to a position substantially directly over the first frame 14. Here, both the frames 14 and 16 are partially rotated on the rotatable couplings 40 and 42 of the dual lobe eccentric coupler 30, but in same clockwise or counter-clockwise directions. Accordingly, the second frame 16 is moved closer to the first frame 14 and laterally thereof Accordingly, the pattern 46 of mounting or bolt clearance holes 50 on the base portion 20 of the second frame 16 is rotated into substantially alignment with the pattern 44 of mounting or bolt clearance holes 48 on the base portion 18 of the first frame 14. Thus, when present the mounting post or pole 12 on the base portion 20 of the second frame 16 is rotationally re-orientated relative to the base portion 18 of the first frame 14 and its mounting orientation relative to the vehicle floor or other mounting surface S, while also being repositioned substantially directly above and in alignment with the mount position of the base portion 18 of the first frame 14.

As illustrated here, the adjustable eccentric mounting apparatus 10 is operable to move the second frame 16 into any position relative to the first frame 14 within the circular range fixed by the distance between the rotatable couplings 40 and 42 of the dual lobe eccentric coupler 30 in combination with the offset distance between the rotatable couplings 40 and 42 and the respective first and second patterns 44 and 46 of mounting or bolt clearance holes 48 and 50 on the base portions 18 and 20 of the first and second frames 14 and 16. The possible positions of the second frame 16 relative to the first frame 14 include the position illustrated here with the pattern 46 of mounting or bolt clearance holes 50 on the base portion 20 of the second frame 16 is rotated into substantially alignment with the pattern 44 of mounting or bolt clearance holes 48 on the base portion 18 of the first frame 14.

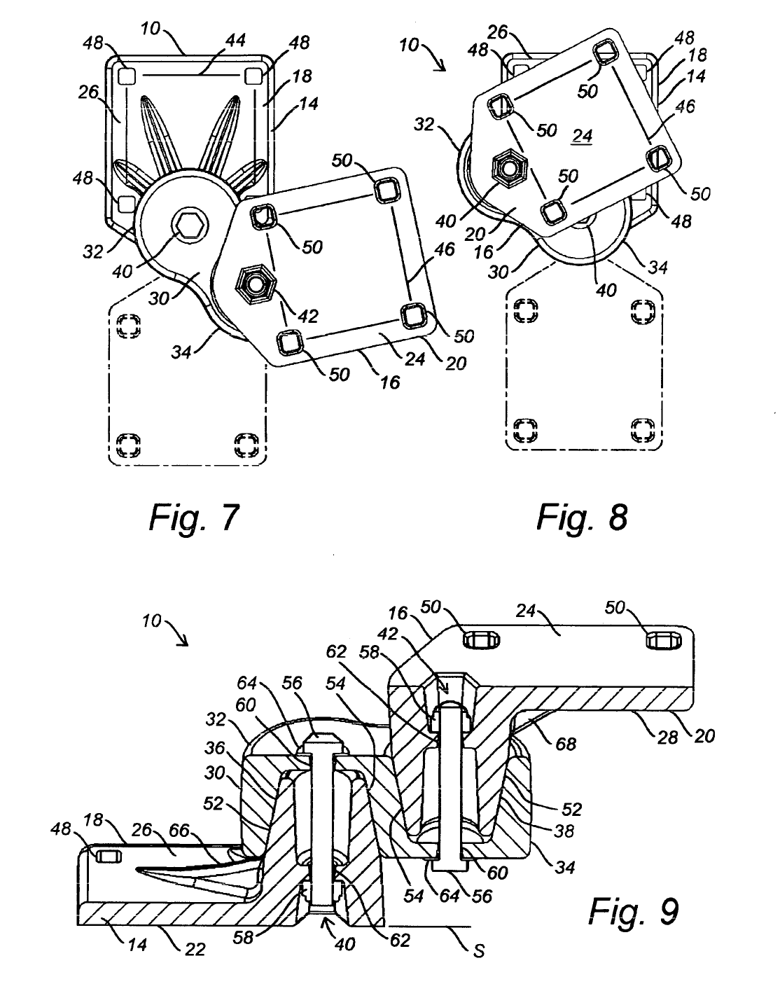

FIG. 9 is a cross-section view of the adjustable eccentric mounting apparatus 10 with the second frame 16 being extended on the eccentric coupler 30 a maximum distance from the first frame 14. Here, both the rotatable couplings 40 and 42 are illustrated by example and without limitation as having a projected male axel portion 52 sized to fit into a mating recessed female socket portion 54. By example and without limitation the axel portions 52 are illustrated as projections from the respective second mounting faces 26 and 28 of the respective base portions 18 and 20 of the first and second frames 14 and 16. By example and without limitation the mating socket portions 54 are illustrated as recesses in the eccentric coupler 30. The recessed mating socket portions 54 are illustrated as oriented facing in substantially opposite directions one from the other so as to receive the axel portions 52 of the first and second frames 14, 16 when the respective first mounting face 22 and 24 of the base portions 18 and 20 are oriented facing toward one another, as illustrated. The mating socket portions 54 are spaced apart from one another in each of the two lobes 32 and 34 of the eccentric coupler 30, which provides the eccentric offset distance between the rotatable couplings 40 and 42 and the respective first and second mounting or bolt patterns 44 and 46 of the respective first mounting face 22 and 24 on the base portions 18 and 20 of the first and second frames 14 and 16, respectively.

As illustrated here by example and without limitation, the axel portions 52 and mating socket portions 54 are mutually structured to nest the axel portions 52 into mating socket portions 54. For example, the axel portions 52 and mating socket portions 54 are formed into mating cone and funnel shapes with a small draft or taper. The axel and socket portions 52, 54 permit the rotatable couplings 40 and 42 to rotate full circle, while their mating cone and funnel shapes cause the rotatable couplings 40 and 42 substantially interlock due to friction when loaded with the weight of the second frame 16 and eccentric coupler 30. The mating cone and funnel shapes cause the rotatable couplings 40 and 42 thus form the respective internal locking mechanisms 36 and 38 between the coupler 30 and each of the respective first and second frames 14, 16 for securing the first mounting face 22 of the second frame 16 at a selected radial and rotational position relative to the first mounting face 24 of the first frame 14.

Optionally, the internal locking mechanisms 36 and 38 also include means for securing the rotatable couplings 40 and 42 against separation of the mating axel and socket portions 52, 54. By example and without limitation, a bolt 56 and nut 58 are provided through holes 60 and 62 in the respective coupler 30 and first and second frames 14, 16 and aligned with the axel and socket portions 52, 54. Bushings 64 are optionally provided in the coupler holes 60 to ease rotation of the rotatable couplings 40 and 42. Additionally, the bolts 56 and nuts 58 may be tightened to secure the rotatable couplings 40, 42 with the first and second frames 14, 16 in a desired relative position and orientation.

Optionally, one or more gussets 66 and 68 are formed between the axel portions 52 of the rotatable couplings 40 and 42 and the respective second mounting faces 26 and 28 of the respective base portions 18 and 20 of the first and second frames 14 and 16 when the axel portions 52 of the rotatable couplings 40 and 42 are offset from the patterns 44 and 46 of mounting or bolt clearance holes 48 and 50 in the respective base portions 18 and 20 of the first and second frames 14 and 16, as illustrated. The gussets 66, 68 provide support for the rotatable couplings 40 and 42 while the relative range of motion of the first and second frames 14 and 16 is maximized.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1: An eccentric mount, comprising:
a first substantially rigid frame having a first face structured for being fixedly attached to a mounting surface and a second face;
a second substantially rigid frame having a first face facing away from the first face of the first frame and being structured for an external object being fixedly attached thereto and a second face; and
an eccentric coupler being fully rotatably coupled between each of the first and second frames, a first portion of the coupler being fully rotatably coupled to the second face of the first frame, and a second portion of the coupler being offset from the first portion and being fully rotatably coupled to the second face of the second frame.

2: The mount of claim 1, further comprising a first fully rotatable coupling between the first portion of the coupler and the second face of the first frame, and a second fully rotatable coupling between the second offset portion of the coupler and the second face of the second frame.

3: The mount of claim 2 wherein each of the first and second fully rotatable couplings further comprises an internal locking mechanism structured for securing the second frame at a selected radial and rotational position relative to the first frame.

4: The mount of claim 3 wherein one or more of the first and second fully rotatable couplings further comprises an axel portion and a mating socket portion.

5: The mount of claim 4 wherein the axel portion further comprises an external taper, and the mating socket portion further comprises a mating internal taper.

6: The mount of claim 4 wherein the second face of each of the first and second frames further comprises the axel portion of one of the fully rotatable couplings, and the eccentric coupler further comprises a pair of the mating socket portions with a second one of the mating socket portions being laterally offset and facing in a substantially opposite direction from a first one of the mating socket portions.

7: The mount of claim 4 wherein one or more of the frames further comprises a mounting hole pattern formed in the first face and a lateral offset between the mounting hole pattern and the fully rotatable coupling.

8: The mount of claim 7 wherein the first and second frames further comprise substantially identical frames.

9: An eccentric mount, comprising:
first and second substantially rigid frames each first and second opposing mounting surfaces being adapted for being fixedly attached to a surface external thereto; and
means for eccentrically rotatably interconnecting the respective second mounting surfaces of the first and second frames for relative eccentric motion of the first mounting surface of the second frame to any point within a predetermined radial distance of the first mounting surface of the first frame.

10: The mount of claim 9, further comprising an eccentric coupler, and wherein the means for eccentrically rotatably interconnecting the respective second mounting surfaces of the first and second frames further comprises a means for fully rotatably coupling the eccentric coupler to each of the respective second mounting surfaces of the first and second frames, with the means for fully rotatably coupling the eccentric coupler to the second mounting surface of the second frame being laterally offset from the means for fully rotatably coupling the eccentric coupler to the second mounting surface of the first frame.

11: The mount of claim 10, further comprising a means for fixing the first mounting surface of the second frame in a fixed position relative to the first mounting surface of the first frame.

12: The mount of claim 10 wherein each of the respective first opposing mounting surfaces further comprises a mounting portion thereof being adapted for being fixedly attached to a surface external thereto, and further comprising a means for laterally offsetting the mounting portion of each of the respective second opposing mounting surfaces relative to the means for fully rotatably coupling the eccentric coupler to each of the respective first mounting surfaces of the first and second frames.

13: The mount of claim 12 wherein the fully rotatably coupling means further comprises means for nesting a projected male portion into a mating recessed female portion.

14: The mount of claim 13 wherein the respective second mounting surfaces of the first and second frames each further comprises the projected male portion of the fully rotatably coupling means; and
the eccentric coupler further comprises the mating recessed female portion of a first of the fully rotatably coupling means oriented facing toward the second mounting surface of the first frame, and the mating recessed female portion of a second of the fully rotatably coupling means oriented facing toward the second mounting surface of the second frame and being offset laterally therefrom and facing substantially oppositely thereof.

15: An eccentric mount, comprising:
first and second substantially rigid frames each having a first mounting face formed at a base portion thereof and structured for being fixedly attached to a mounting surface and a second mounting face formed on the base portion opposite from the first face;
a dual lobe eccentric coupler that is rotatably coupled between the second mounting faces of the first and second frames, a first lobe portion of the coupler being fully rotatably coupled to the second face of the first frame and a second lobe portion laterally offset from the first lobe portion and being fully rotatably coupled to the second face of the second frame; and
an internal locking mechanism between the coupler and each of the first and second frames for securing the first mounting face of the second frame at a selected radial and rotational lateral position relative to the first mounting face of the first frame.

16: The mount of claim 15, further comprising a first fully rotatable coupling being rotatably coupled between the first lobe portion of the coupler and the second mounting face of the first frame, and a second fully rotatable coupling being rotatably coupled between the second lobe portion of the coupler and the second face of the second frame.

17: The mount of claim 16 wherein each of the first and second fully rotatable couplings further comprises an externally tapered male axel portion and a mating internally tapered female socket portion.

18: The mount of claim 17 wherein the second face of each of the first and second frames further comprises the male axel portion of one of the fully rotatable couplings, and the eccentric coupler further comprises a pair of the mating female socket portions with a first one of the mating female socket portions being recessed in the first lobe portion of the coupler and a second one of the mating female socket portions being recessed in the second lobe portion of the coupler, the second one of the mating female socket portions being oriented facing in a substantially opposite direction from the first one of the mating socket portions.

19: The mount of claim 18 wherein the first mounting face of each of the first and second frames further comprises a pattern of a plurality of mounting holes formed therein and being positioned eccentric of the male axel portion of the fully rotatable coupling.

20: The mount of claim 19 wherein the first and second frames further comprise substantially identical frames.
